(19) United States
(12) Patent Application Publication
(10) Pub. No.: US 2008/0296044 A1
(43) Pub. Date: Dec. 4, 2008

(54) FLEXIBLE FLAT CABLE

(76) Inventor: Chin-Chih CHIANG, Taipei (TW)

Correspondence Address: HDSL, P.O. BOX 220746, CHANTILLY, VA, 20153-0746, US

(21) Appl. No.: 12/014,169

(22) Filed: Jan. 15, 2008

(30) Foreign Application Priority Data
Jun. 1, 2007 (TW) 096209022

(51) Int. Cl. H01B 7/08

(52) U.S. Cl. 174/117 FF

(57) ABSTRACT

A flat cable includes a plurality of flat cores arranged at an interval, an insulating layer covering integrally each core, and an adhesive sheet. Both surfaces of the insulating layer are provided with a plurality of grooves to correspond to the cores respectively. The distal end of each core extends beyond the insulating layer and each has a connecting portion. Each connecting portion has two flat surfaces. One of the flat surfaces is used for electrical connection, and the other is adhered to the adhesive sheet. The adhesive sheet is adhered from the distal end of each connecting portion to a portion of the insulating layer. Further, an external surface of the adhesive sheet is colored.

### BACKGROUND OF THE INVENTION

1. Field of the Invention

The present invention relates to a flexible flat cable (FFC), and in particular to a flexible flat cable that can be inserted into a socket of a connector.

2. Description of Prior Art

Electronic products are widely used in modern life, such as a mobile phone, computer, printer or the like. However, since the means for transmitting electronic signals within an electronic product is of a sensitive structure, the assembly of such kind of electronic product should be performed very carefully, otherwise the electronic product may not be operated normally or even get damaged. For example, in a notebook, when a flexible flat cable is inserted into a socket of a connector, the flexible flat cable may be connected to the socket incorrectly due to an improper operation or man-made mistake, thereby affecting the normal function thereof.

Further, as shown in FIG. 1, in a conventional flexible flat cable, an insulating layer 2a is provided respectively on the upper and lower portions of a plurality of cores 1a that are arranged horizontally at an interval in the lengthwise direction thereof. Via a hot pressing process, the two insulating layers 2a are pressed together, thereby covering each core 1a therein to form a unit. However, the above procedure has some drawbacks as follows.

(1) Due to the technical level of the hot pressing process, a gap G may be generated between each core 1a and the two insulating layers 2a. As a result, each core 1a may get oxidized easily when contacting with the air, which affects the transmission of signals and the quality of the flat cable. Further, the connection of the flat cable with a connector may become poor and the cores 1a may fall off easily.

(2) The number of the cores 1a of the flat cable should be determined in advance according to the number of insertion holes of a connector with which the flat cable is used, and the number of the cores cannot be changed after the manufacturing of the flat cable is completed. Therefore, such a procedure does not have adaptability.

(3) Only when the two insulating layers 2a are formed completely, the cores 1a can be covered. Therefore, such a procedure will increase the number of processes and the cost.

Therefore, according to the above, the above-mentioned conventional flexible flat cable has some inconvenience and drawbacks and thus needs to be improved.

In view of the above drawbacks of prior art, the inventor of the present invention has proposed a novel and inventive structure based on his expert experience and researches.

### SUMMARY OF THE INVENTION

The present invention is to provide an improved flat cable, which can be manufactured more easily to reduce the cost. Further, its structure can be separated and a fool-proofing means is provided thereon, so that, during assembly, the flat cable can be inserted into insertion holes of a connector more easily.

The present invention is to provide an improved flat cable, which includes a plurality of flat cores arranged at an interval, an insulating layer covering integrally each core, and an adhesive sheet. Both surfaces of the insulating layer are provided with a plurality of grooves to correspond to the cores respectively. The distal end of each core extends beyond the insulating layer and each has a connecting portion. Each connecting portion has two flat surfaces. One of the flat surfaces is used for electrical connection, and the other is adhered to the adhesive sheet. The adhesive sheet is adhered from the distal end of each connecting portion to a portion of the insulating layer. Further, an external surface of the adhesive sheet is colored.

### BRIEF DESCRIPTION OF THE DRAWINGS

FIG. 1 is a cross-sectional view of a conventional flat cable;

FIG. 2 is a partially exploded perspective view of the present invention;

FIG. 3 is a partially top view of the present invention;

FIG. 4 is a cross-sectional view taken along the line 4-4 in FIG. 3; and

FIG. 5 is a partially perspective view of the present invention.

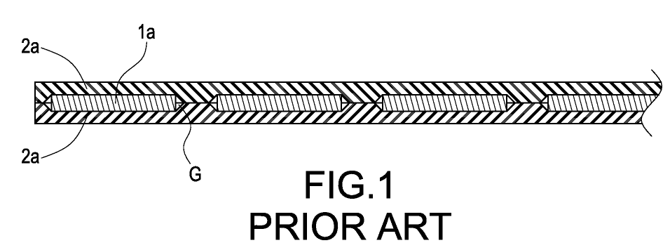

### DETAILED DESCRIPTION OF THE INVENTION

In order to make the Examiner to further understand the characteristics and technical contents of the present invention, a detailed description related thereto will be explained with reference to the accompanying drawings. However, the drawings are illustrative only and are not used to limit the scope of the present invention.

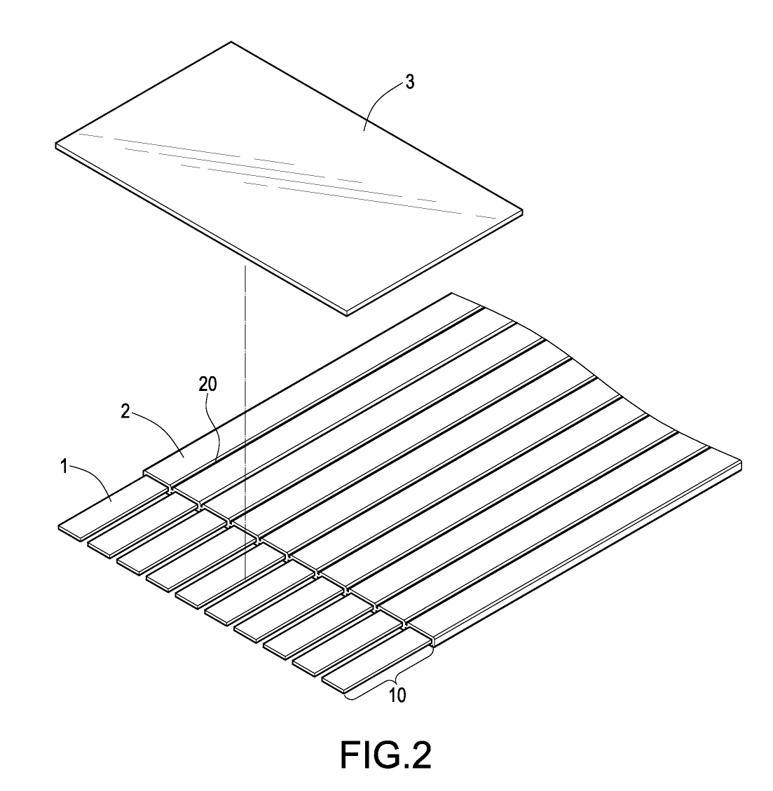

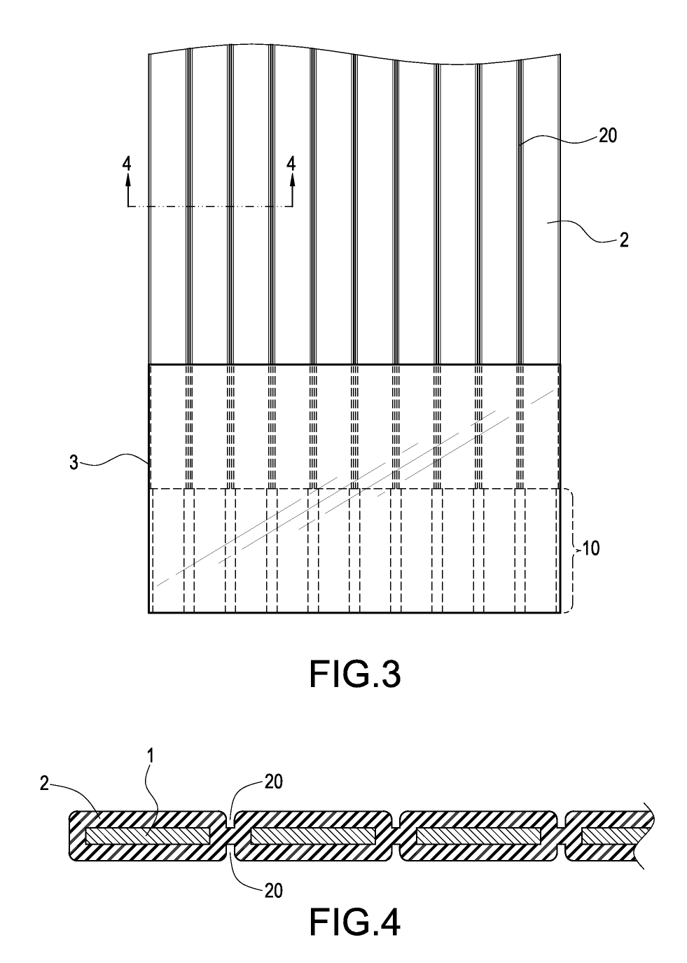

FIG. 2 is a partially exploded perspective view of the present invention. FIG. 3 is a partially top view of the present invention. FIG. 4 is a cross-sectional view taken along the line 4-4 in FIG. 3. The present invention provides an improved flat cable, which includes a plurality of cores 1, an insulating layer 2 covering the cores 1, and an adhesive sheet 3.

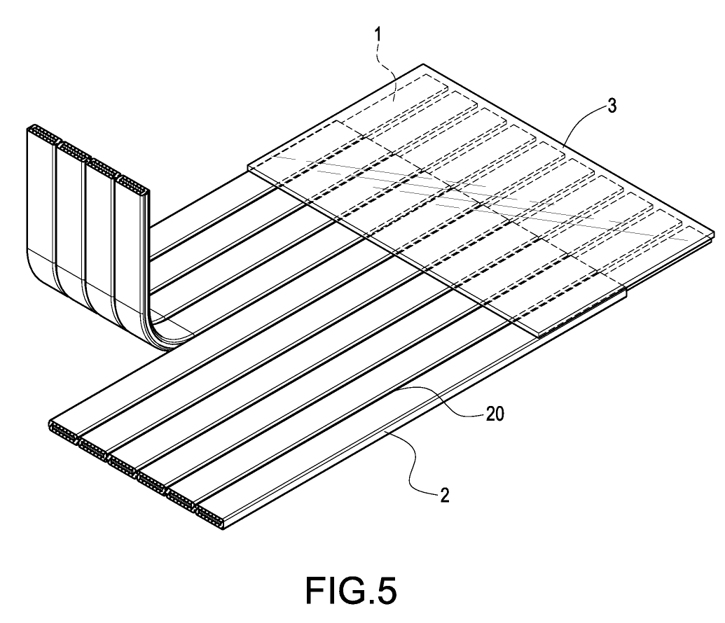

Each core 1 is flat and arranged horizontally at an interval in the lengthwise direction thereof. The cores are integrally covered by the insulating layer 2, thereby reducing the number of processes and the cost. Further, each core 1 is separated from one another by means of the insulating layer 2. The upper and lower surfaces of the insulating layer 2 are provided with a plurality of grooves 20 to correspond to the interval between each core 1 respectively. According to the number of insertion holes of the connector into which the flat cable is inserted, a user can tear the flat cable directly at an arbitrary groove 20 (FIG. 5), thereby obtaining a new flat cable of a desired number of cores 1.

In addition, the distal end of each core 1 extends beyond the insulating layer 2 and has a connecting portion 10. Each connecting portion 10 has two flat surfaces exposed to the outside. One of the two flat surfaces is electrically connected with the connector into which the flat cable is inserted, and the other is adhered to the adhesive sheet 3 (FIG. 3). The front end of the adhesive sheet 3 is in flush with the distal end of each connecting portion 10. The rear end of the adhesive sheet 3 covers a portion of the insulating layer 2 adjacent to each connecting portion 10 and is adhered thereto. An external surface of the adhesive sheet 3 is colored, thereby acting as a fool-proofing means. Via this arrangement, an operator or a person who performs the assembling process can identify the exposed connecting surface of each connecting portion 10 clearly, thereby preventing the flat cable from being inserted erroneously into the connector.

Therefore, with the above construction, the improved flat cable of the present invention can be obtained.

Via the improved flat cable of the present invention, the manufacturing process is simpler and the cost is reduced. In addition, the structure of the flat cable can be separated according to the number of insertion holes of the connector into which the flat cable is inserted, and thus it is very convenient to perform the assembling process. Moreover, during the assembling process, the adhesive sheet 3 can remind the operator of the correct inserting direction, thereby preventing the failure in connection due to the erroneous insertion. The adhesive sheet 3 is adhered from the distal end of each connecting portion 10 to a portion of the insulating layer 2, thereby preventing the fact that the cores 2 are too soft to be inserted into the insertion holes of the connector. Thus, it is easier to perform the inserting process. According to the above, the present invention already achieves the desired objects and solves the drawbacks of prior art. Further, the present invention really has novelty and inventive steps. Therefore, the present invention conforms to the requirements for a utility model patent.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A flat cable, comprising:
a plurality of cores, each core being flat and arranged at an interval;
an insulating layer integrally covering the cores, both surfaces of the insulating layer being provided with a plurality of grooves to correspond to the cores respectively; and
an adhesive sheet;
wherein a distal end of each core extends beyond the insulating layer and each has a connecting portion, each connecting portion has two flat surfaces, one of the flat surfaces is used for electrical connection, and the other is adhered to the adhesive sheet, the adhesive sheet is adhered from the distal end of each connecting portion to a portion of the insulating layer, and an external surface of the adhesive sheet is colored.
